(19) United States
(12) Patent Application Publication
(10) Pub. No.: US 2009/0182085 A1
(43) Pub. Date: Jul. 16, 2009

(54) POLYURETHANE-BASED RETENTION, COVERING, FILLING AND REINFORCEMENT COMPOSITION

(76) Inventors: Vladimir A. Escobar Barrios, San Luis Potosi (MX); Raul Maldonado Arellano, San Luis Potosi (MX)

Correspondence Address: 3M INNOVATIVE PROPERTIES COMPANY, PO BOX 33427, ST. PAUL, MN, 55133-3427, US

(21) Appl. No.: 12/162,515

(22) PCT Filed: Jan. 25, 2007
(86) PCT No.: PCT/US07/01893

§ 371 Date: Nov. 17, 2008

(30) Foreign Application Priority Data
Jan. 30, 2006 (MX) 2006001221

(51) Int. Cl. C08K 3/26; C08K 3/04; C08L 75/00; C08K 3/34

(52) U.S. Cl. 524/425; 524/500; 524/451

(57) ABSTRACT

The present invention is related to the usage of a composition of polyurethanes to obtain adequate materials for retention, resistance, reinforcement, covering and sealing of geological and architectonical structures, including the common used building materials such as brick, concrete, masonry, partition wall, clay, among others.

### BACKGROUND

Polyurethane-based compounds have been widely studied and commercially exploited, due to diversity of mechanical characteristics to be achieved with polyurethanes.

Traditionally, polyurethanes have been synthesized from polyol reaction, based on polyethers and/or polyesters, with pure polyisocyanate, in mixtures or prepolymers, which contain free isocyanate groups (NCO).

NCO groups react with hydroxyl groups of polyol carrying out polycondensation reactions.

The different polyol types, as well as polyisocyanates, have performed a diversity of physical-chemical polyurethane characteristics; therefore, these have been used to make sealers for structures or joints, made of cement and/or asphalt, and generally, products that exhibit an hydrophobic behavior, therefore, they are useful as waterproof material.

Basically, there are polyurethanes from one or two components. The first ones are prepolymers that contain NCO groups, into their structures, which are able to react with environment humidity, or with catalysts, as tin octate, tin dilaurate dibutyl, or amines.

On the other hand, two components polyurethanes are produced from a mixture of any polyisocyanate, as toluene diphenyl diisocyanate (TDI) or methylene diphenyl diisocyanate (MDI), with any polyether or polyester-based polyol. In order to obtain elastomeric characteristics in this case, it is generally carried out as the reaction of polyisocyanate with the short-chain as the 1,4-butanediol, along with the long-chain polyether or polyester-based polyol.

On the other hand, elastomeric components with hydroxyl functional groups have been used, as hydroxylated polybutadiene, commercially available through Sartomer Inc., known as polyBd, and specifically the product R-45HT. The advantage of this type of materials lies in the polybutadiene hydrophobic character, which makes it ideal for applications where a waterproof effect is required. Additionally to the above, is that the polybutadiene exhibits an elastomeric behavior that provides the resulting polyurethane with resilience characteristics, which in another way can be obtained by using foam agents to create cavities inside the polyurethane matrix.

The polybutadiene with hydroxyl functional groups, also contain functional groups as double bonds, which represent points through which such material can suffer degradation reactions, especially generation of high molecular weight insoluble particles, known as gels. The above implies certain disadvantages of this kind of material when the polyurethane is to be exposed to outside elements; therefore, material degradation is facilitated, unless it is properly protected through UV-rays protectors and antioxidants usage.

U.S. Pat. Nos. 4,460,737 and 4,443,578 broadly describe polyurethanes usage as filling materials, especially as cold-joints sealers. Therein, qualities and advantages of hydroxyl groups containing polybutadiene use are highlighted, as that described above. Nevertheless, thermal-oxidative risks are not explicitly mentioned when using such material.

There are other types of materials that are suitable for use in sealer formulations, as described in U.S. Pat. No. 4,778,831, where polyester unsaturated resins are used together with crosslinking agents, as styrene and toluene vinyl, along with polyurethane-based plasticizers, styrene-butadiene copolymers, styrene-butadiene, or inclusively, the polyurethane prepolymers reaction product with polybutadiene that contain hydroxyl groups. Related to the last reaction product, the patent only mentions ether glycol polytetramethylene polyurethane-based prepolymers usage, which differs from the present invention where a polybutadiene-based prepolymer is used. Besides, in such patent it also describes polybutadiene use with functional groups and does not mention saturated or hydrogenated polybutadiene usage with functional groups, which is also different from the present invention.

On the other hand, polyurethanes and/or polyurethanes compounds have been used as cracks fillings and retention material to avoid hillside washouts. For example, patent JP 07025964 describes the usage of two-component foamed polyurethane, produced from a polyol with at least 2 hydroxyl groups per polymeric chain and does not use any filler in the formula. Patent DE 3332256 uses polyether and polyester-based prepolymers/polyols mixed, without any filler. The obtained product in such patent is used for soil consolidation.

On the other hand, patent SE 9903008 describes the usage of one volatile polybutadiene to reinforce walls and rocks. Again, filler material use is not described.

Document WO 200179321, describes a polyisocyanate with a polyol reaction, mineral and organics fillers, and water. The product from such reaction is specifically used to reinforce stones in the mining industry.

On above mentioned documents, it is certain that polyurethane is generated from polyisocyanates with polyols reaction, these last are polyether and polyester basically, which exhibit less resistance to hydrolysis compared with components such as polybutadiene.

On the other hand, fillers have been used in polyurethanes to give different mechanical characteristics and reduce formula costs. Among the most common fillers are silica, powders, talc, calcium silicate, calcium carbonate, zirconium silicate, kaolin, graphite, aluminum oxide, titanium dioxide, polyester fibers, nylon fibers, polypropylene fibers, and glass fibers.

On filling materials, such as sealers, depending on the quantity and type of fillers to be used, mechanical characteristics can drastically vary, and elastic materials can be obtained with Shore A hardness from 20 up to 35, or materials with higher Shore A hardness, from 40 to 60, so defining its application.

Generally, filling materials such as concrete repairs, have limited fracture width to be filled, basically due to material rigidity to be used for such purposes, especially products that are made with epoxy-based materials. Besides, the fracture limit width with such materials is usually about 2.54 cm.

### SUMMARY

The present invention provides a polyurethane compound comprising hydrogenated elastomer with hydroxyl functional groups, elastomer based polyurethane prepolymer, filler material, and at least one additive selected from the group consisting of antioxidants, rheological modifiers, oils, and carbon black.

In an alternate embodiment, the polyurethane compound includes a catalyst. The catalyst may comprise an amine or tin compound. In more specific aspects, this comprises triethanolamine, lauryl dimethyl amine oxide, or tin dibutyl dilaurate. In a more specific aspect, the catalyst typically comprises no greater than about 1% of the compound total weight, and more typically no greater than about 0.5% of the compound total weight.

In another embodiment, the hydrogenated elastomer is a telechelic hydrogenated elastomer. In specific embodiments, the hydrogenated elastomer typically comprises from about 20% to about 60% of the compound total weight and, more typically, from about 22% to about 40% of the compound total weight.

In another embodiment, the polyurethane prepolymer is polybutadiene-based with methylene diphenyl diisocyanate, which confer its elastomeric character. In a specific aspect, the elastomer-based prepolymer includes from about 8.0% by weight to about 14.0% by weight of isocyanate groups. In a specific embodiment, the polybutadiene-based elastomeric polyurethane prepolymer comprises from about 10% to about 20% of the compound total weight.

In yet another embodiment, the filler comprises at least one of sand, talc and/or calcium carbonate. The filler typically has an average particle size of no greater than about 1700 microns, and more typically, no greater than about 500 microns. In a more specific embodiment, the filler comprises a mixture of sand and talc and/or calcium carbonate in a weight ratio of about 0.5 to about 2 of sand to talc and/or calcium carbonate. In an even more specific embodiments, the filler typically comprises from about 40% to about 70% of the compound total weight and, more typically, from about 50% to about 60% of the compound total weight.

In another aspect of the invention, the additive typically comprises no greater than about 0.5 weight percent antioxidant, no greater than about 0.2 weight percent carbon black, no greater than about 1.5 weight percent rheological modifier, and/or no greater than about 6 weight percent aliphatic oil.

The present invention provides a versatile spreadable polyurethane compound that may be used, for example, as crack filler, as a coating or covering, for soil retention purposes, or for other geological and/or architectural purposes. Advantages of certain embodiments of the invention include the compound's durability, the ease with which it can be applied, its ability to be modified so its working time and drying/curing time can be adjusted depending on the particular intended end use application, its high resistance to hydrolysis, and its chemical resistance.

### BRIEF DESCRIPTION OF THE DRAWINGS

FIG. 1 is a graph showing the relationship between stress and percent deformation for several sample materials according to the invention;

FIG. 2 is a graph showing the relationship between heat flow and time for several samples;

FIGS. 3 and 4 are graphs showing the relationship between heat flow and temperature for several samples; and

FIG. 5 is a graph showing the relationship between elastic modulus and temperature.

### DETAILED DESCRIPTION

The composition of the present invention is made of the following materials:
a) Telechelic hydrogenated elastomer-based polyurethane with hydroxyl groups on each side of polymeric chains. The telechelic term means that a functional group is attached at each side of polymeric chain. Such material is important since facilitates reaction of hydroxyl groups with isocyanate groups of diisocyanate material. On the other hand, hydrogenated term means that double bonds into elastomer structure have been saturated. Commercially available example of this kind of material is that offered by Sartomer Inc.
b) Elastomer-based polyurethane prepolymer, particularly polybutadiene-based with methylene diphenyl diisocyanate, which may have a content of isocyanate groups from 8.0 to a 14.0% weight.
c) Aggregate, such as sand, with particle size up to 1700 microns, preferably not higher than 500 microns, and/or calcium carbonate and/or talc in a weight ratio sand/calcium carbonate and/or talc of 0.5 to 2.
d) Additives such as antioxidants, rheological modifiers, oils and carbon black.
e) Catalyst based on compounds with amines and/or tin. For example, triethanolamine or lauryl dimethyl amine oxide, or tin dibutyl dilaurate.

A suitable elastomer for the elastomer of subsection a is a saturated polybutadiene, at least at 98%, with hydroxyl functional groups on each side of the polymer chains, with a molecular weight of 3000 g/mol and a glass transition temperature of −55° C.

When using a saturated polybutadiene, as described above, it is to correct the hydrolysis problem that polyether and/or polyester polyol-based polyurethane exhibits; due to the fact that saturated polybutadiene has a hydrophobic character along with its chemical structure that exhibits better mechanical and environmental degradation resistances, as well.

Regarding the polyurethane prepolymer composition, it is a hydroxylated polybutadiene-based material, synthesized via anionic polymerization, which assures that there are 2 functional groups per each polymeric chain. Such polybutadiene prepolymer material has been reacted with methylenediphenyl diisocyanate and with isomers mixing 1,2 and 1,4 of methylenediphenyl diisocyanate. The isocyanate groups content can be of 6 to 15%, preferably from 8 to 14%.

The weight ratio between saturated elastomer and polybutadiene-based prepolymer can vary among saturated elastomer/prepolymer from 1 to 3.

A suitable filler is sand or a sand/calcium carbonate mixture, or sand/talc in 0.1 to 2 ratio with the particle size mentioned above. The response of the generated compound, in terms of mechanical behavior when subjected to a compression effort, depends on particle quantity and size, providing the possibility of having whether a plastic or elastic response.

On the other hand, aliphatic oil has been used in order to reduce viscosity, which allows the compound to be more easily applied along the cavity that should be filled. Nevertheless, it is important to note that oil presence usually increases the product curing time. Therefore, the amount of oil in the present invention is generally not greater than 6% weight of the total formula.

Regarding additives and specifically related to the rheological modifier, the rheological modifier is used to minimize the settling of the aggregate. Traditionally, it is used in percentages not greater than 5% weight and its chemical nature is defined in terms of bentonite. The rheological modifier is used in the present invention in amounts between 1 and 2% weight, preferably between 1.2 and 1.7% weight.

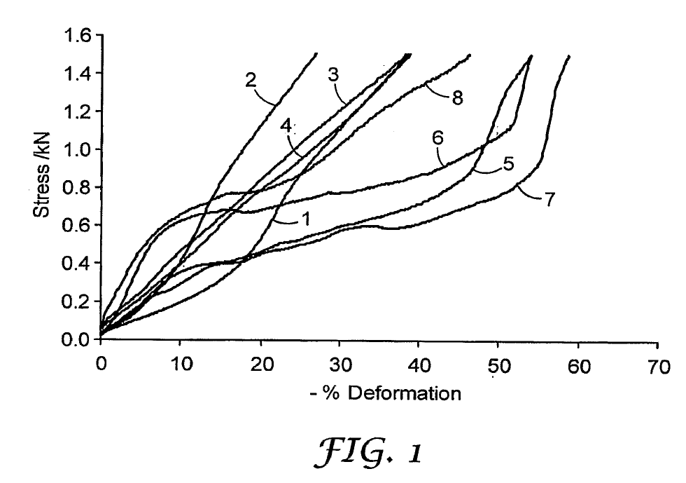

Referring now to the Figures, FIG. 1 shows resistance to compression, where obtained results are shown for a diisocyanate content of 8% (samples 1 to 4) and 13% (samples 5 to 8). Samples 1 to 4 have an aggregate particle size between 1.7 and 1 mm, samples 2 and 6 have an aggregate particle size between 1 mm and 850 microns. Samples 3 and 7 have an aggregate particle size between 850 and 500 microns, samples 4 and 8 have a particle size smaller than 500 microns.

Aggregate types to be used are common silicates such as sand or fillers such as talc or calcium carbonate, alone or combined with sand/talc or calcium carbonate from 0.5 to 2 weight ratio.

Particle sizes for sand can be up to 1700 microns, but generally not greater than 500 microns.

Samples were made from the above data using sand, which exhibited a particle size that did not exceed 500 microns. Such materials were submitted to tension-elongation testing, according with ASTM D-412 standard, and obtaining the results shown on Table 1.

TABLE 1
Mechanical behavior

| | | |
|---|---|---|
| Strength to 100% deformation | MPa | 1.14 |
| Tensile strength | MPa | 1.26 |
| Deformation to rupture | % | 154.75 |

Related to the additives, one of the most significant is the antioxidant. Antioxidants are widely used to reduce adverse effects from exposure to outside elements. A phenol type antioxidant has been used on the present invention, such as bencenpropanol acid ester, and its amount can vary from 0.25 to 1% weight related to the current polymer material content in the formula.

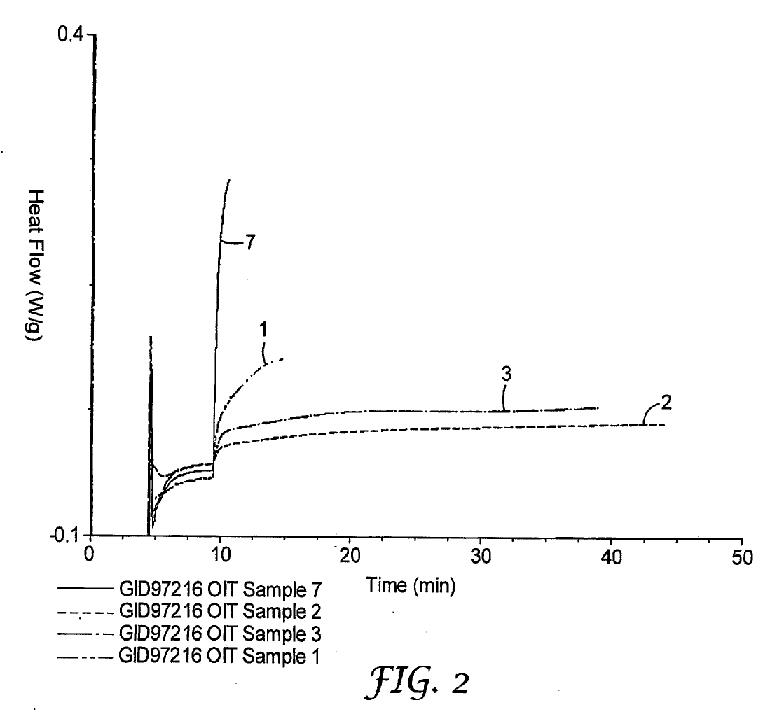

The thermal behavior is shown in FIG. 2, i.e., the antioxidant content effect for a formula that uses polybutadiene-based prepolymer and methylendiphenyl diisocyanate, with a diisocyanate content of 13% w/w. It can be observed that heat generated by oxidation process is reduced when the antioxidant content increases up to 1% weight (sample 2), with respect to sample without antioxidant (sample 7). Samples 1 and 3 have 0.25% y 0.5% weight, respectively.

On the other hand, the onset oxidation temperature (OOT), as indicated by its name, is the temperature at which the sample oxidation process is first detected, and in this case, the possible greater temperature is desired.

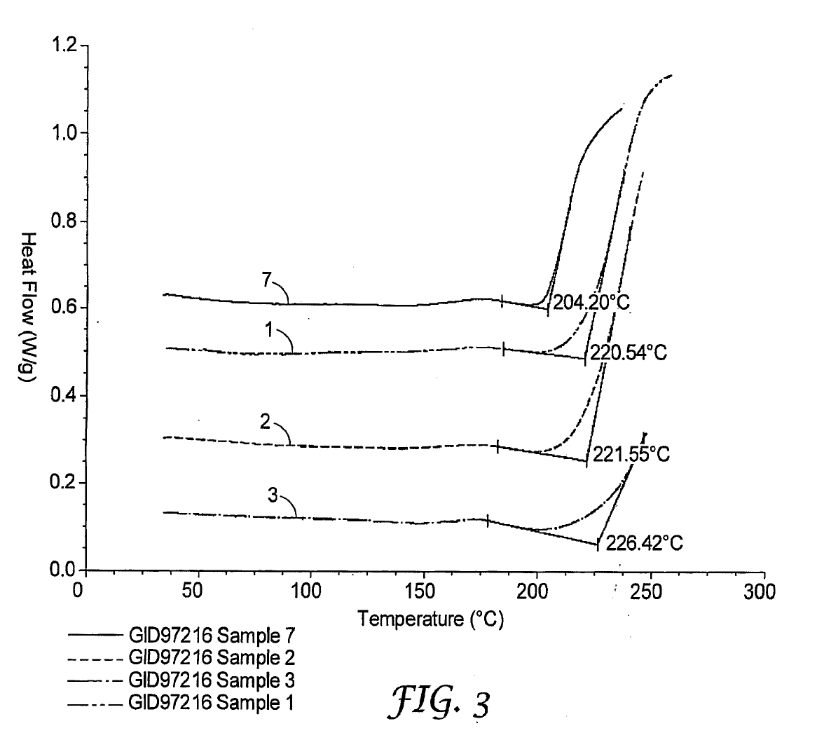

In FIG. 3, OOT data is shown relative to the different antioxidant contents. Sample 1 with 0.25% antioxidant, sample 3 with 0.5% antioxidant, sample 2 with 1% antioxidant and sample 7 without antioxidant.

On the other hand, product performance temperatures can be determined through a scanning differential calorimetry.

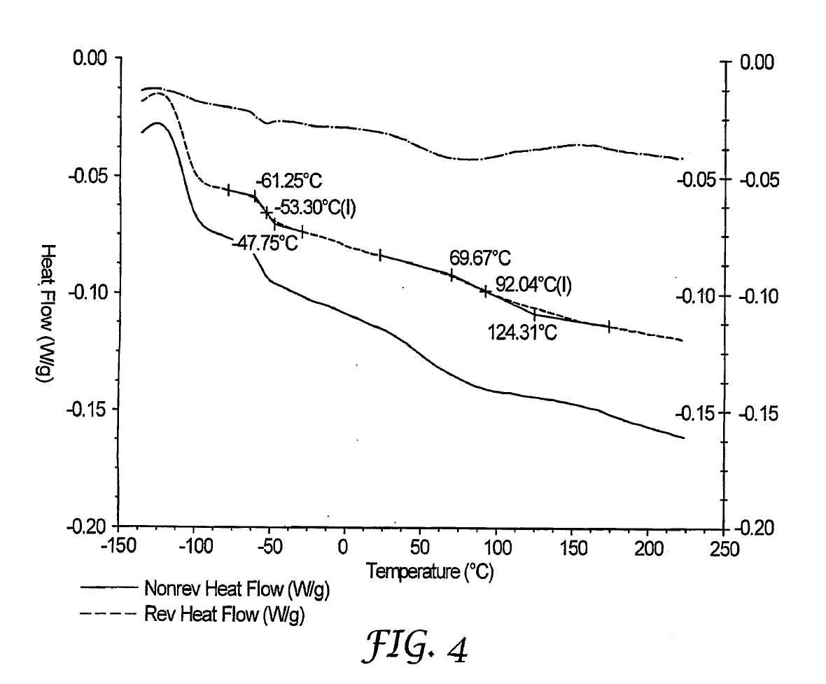

In FIG. 4, a thermogram obtained by scanning differential calorimetry is shown from a representative sample of the invention.

Products of the present invention exhibit a performance temperature interval from −53° C. to 85° C., which is broader than traditional polyurethanes sealers.

On the other hand, and related to another important additive such as the catalyst, there are several types of catalysts, even though those amine-based are particularly important, and even more, those that are tin-based, due to their high catalytic activity, which means that the reaction between isocyanate/hydroxyl groups is carried out more quickly and efficiently. The above implies that working time can be manipulated, i.e., the time during it is possible to manipulate the compound once different component mixing has been done, differs depending on amount and catalyst type used.

For example, tin-based catalysts are more effective and are used when the product is desired to have a short working time, as well as a shorter curing time. On the other hand, when using amine-based catalysts, working time is greater, as well as the curing time.

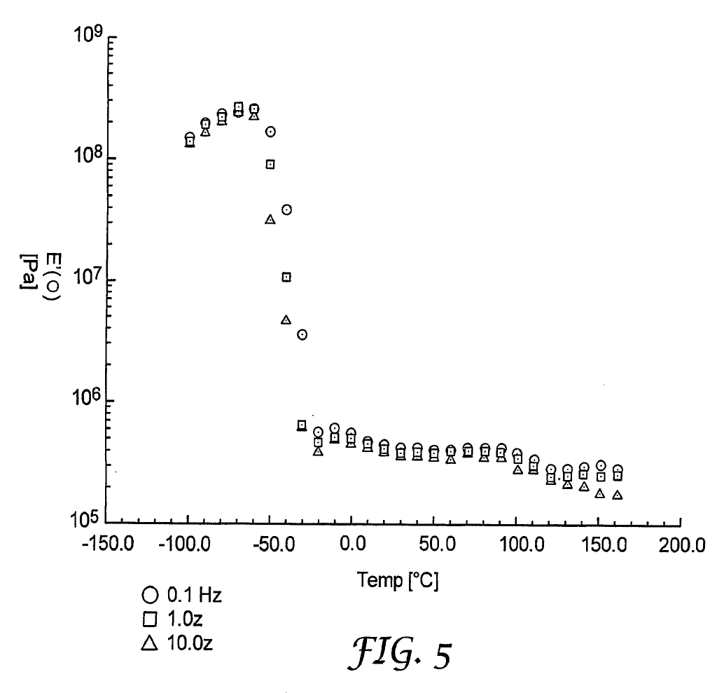

On the other hand, the products described in the present invention exhibit a practically independent rheological behavior from the frequency in which the product is evaluated. Such behavior is exemplified in FIG. 5, where the elastic modulus results are shown against temperature, where triangles correspond to 0.1 Hertz, squares to 1 Hertz and rhombus to 10 Hertz. The importance of these results resides in the possibility to use the product under different usage conditions, for example, as filling in conditions where compression as well as tension movements frequency is low or high, without dramatically modifying the product mechanical response obtained in the present invention.

On the other hand, it is important to point out that rheological behavior was evaluated in a tension-compression mode. This is relevant since a traditional evaluation of polyurethane sealers comprises tension-compression test, made at −29° C., in order to obtain the modulus and elongation of tested material. In the case of the present invention, from FIG. 5, it must be pointed out that elastic modulus obtained at −30° C. is between 400 and 500 KPa; and that such value is similar to that obtained at higher temperatures (up to 90° C.); which shows that the product of this invention is able to maintain its mechanical integrity when tension/compression cyclical stress is applied, even to low temperatures; as the elastic modulus is maintained at an acceptable value where the material will be able to dissipate the applied stress without having any material degradation such as fractures, which was also visually verified in accordance with the evaluated samples.

Related to resistance to hydrolysis, the products mentioned herein, were submerged in hot water at 70° C. during 7 days, in order to subsequently evaluate them by means of a tension-elongation test. Obtained results indicate that tensile strength was reduced to 13% and break elongation was reduced 4.5%. This data indicates that products mentioned herein do not exhibit a remarkable mechanical degradation after being submerged in hot water.

On the other hand, the products mentioned herein, exhibit resistance to certain chemicals, such as organic solvents (cyclohexane, Toluene), alcohols (ethanol, methanol, isopropyl alcohol) and methyl ethyl ketone.

In Table 2, there are some results in terms of resistance to chemical compounds when the product was exposed to them. The product was made from a hydrogenated elastomer/prepolymer mixture (with a 13% diisocyanates content) mixed with sand (with a particle size not greater than 500 microns) and additives, such as carbon black and antioxidant. Samples were submerged in different chemical products during 48 hours at room temperature.

TABLE 2
Chemical resistance

| Chemical product | Area variation, % |
|---|---|
| Methanol | 1.4 |
| Ethanol | 0 |
| Isopropanol | 0 |
| Methyl ethyl ketone | 2.1 |
| Cyclohexane | −2.5 |
| Toluene | −4.3 |

It can be said that from Table 2, alcohols do not significantly affect the area variation of the compound, but other aggressive chemicals, such as methyl ethyl ketone, cyclohexane and toluene, affect the product modifying its dimensions. Nevertheless, it is important to highlight the test was continuously immersed during 48 hours. When material was directly exposed to these chemical products, i.e., was added to the surface of different product samples, no material surface modification was detected, while such chemical compound was evaporating.

### EXAMPLES

Some examples of typical formulas are described below, without being restrictive related to percentages mentioned therein, as known by those skilled in the art.

### Example 1

One kilogram formula was prepared in a steel container, at room temperature, with the following composition: 27% w/w hydrogenated elastomer with hydroxyl functional groups; 14% w/w polybutadiene-based polyurethane prepolymer with 13% of isocyanate groups; 58.7% w/w aggregates, specifically sand with particle size not greater than 500 microns; 0.1% w/w carbon black, 0.2% w/w antioxidant and 1.2% weight (related to total formula weight) of rheological modifier. Mixing sequence was as follows: first, hydrogenated elastomer and carbon black were mixed and the aggregate was subsequently added, once the mixture becomes homogeneous, the antioxidant and rheological modifier were added, such mixing is denoted as part A. Part B consisted of prepolymer, which was added to part A, previously to apply the product, and it was homogenized for 3-5 minutes.

### Example 2

One kilogram formula was prepared in a steel container, at room temperature, with the following composition: 27% w/w hydrogenated elastomer with hydroxyl functional groups; 14% w/w polybutadiene-based polyurethane prepolymer with 13% of isocyanate groups; 53.7% w/w aggregates, specifically sand with particle size not greater than 500 microns; 5% w/w aliphatic oil, 0.1% w/w carbon black, 0.2% w/w antioxidant and 1.2% weight (related to total formula weight) of rheological modifier. Mixing sequence was as follows: first, aggregated and oil were mixed, hydrogenated elastomer, carbon black, antioxidant and rheological modifier were subsequently added, such mixing is denominated as part A. Part B consisted of prepolymer, which was added to part A, previous to applying product, and it was homogenized for 3-5 minutes.

### Example 3

One kilogram formula was prepared in a steel container, at room temperature, with the following composition: 27% w/w hydrogenated elastomer with hydroxyl functional groups; 14% w/w polybutadiene-based polyurethane prepolymer with 13% of isocyanate groups; 53.7% w/w aggregates specifically sand and calcium carbonate with particle size not greater than 500 microns and in a weight ratio of 2 to 1 of sand to calcium carbonate; 5% w/w aliphatic oil, 0.1% w/w carbon black, 0.2% w/w antioxidant and 1.2% weight (related to total formula weight) of rheological modifier. Mixing sequence was as follows; first, aggregate was mixed (sand and calcium carbonate) with oil, hydrogenated elastomer, carbon black, antioxidant and rheological modifier were subsequently added, such mixing is denominated as part A. Part B consisted of prepolymer, which was added to part A, previous to applying product, and it was homogenized for 3-5 minutes.

### Example 4

One kilogram of formula was prepared in a steel container, at room temperature, with the following composition: 27% w/w hydrogenated elastomer with hydroxyl functional groups; 14% w/w polybutadiene-based polyurethane prepolymer with 13% of isocyanate groups; 58.7% w/w aggregates, specifically sand and calcium carbonate in a weight ratio of 2 to 1 of sand to calcium carbonate with particle size not greater than 500 microns; 0.1% w/w carbon black, 0.2% w/w antioxidant and 1.2% weight (related to total formula weight) of rheological modifier. Mixing sequence was as follows; first, hydrogenated elastomer and carbon black were mixed and aggregate was subsequently added (sand and calcium carbonate), once homogeneous, rheological modifier and antioxidant were added, such mixing is denominated as part A. Part B consisted of prepolymer, which was added to part A, previous to applying product, and it was homogenized for 3-5 minutes.

### Example 5

One kilogram formula was prepared in a steel container, at room temperature, with the following composition: 27% w/w hydrogenated elastomer with hydroxyl functional groups; 14% w/w polybutadiene-based polyurethane prepolymer with 8.3% of isocyanate groups; 53.7% w/w aggregates, specifically sand and calcium carbonate in a weight ratio of 2 to 1 of sand to calcium carbonate with particle size not greater than 500 microns; 5% w/w aliphatic oil; 0.1% w/w carbon black, 0.2% w/w antioxidant and 1.2% weight (related to total formula weight) of rheological modifier. Mixing sequence was as follows; first, the aggregate was mixed (sand and calcium carbonate) with oil, hydrogenated elastomer was subsequently added along with carbon black, antioxidant and rheological modifier, such mixing is denoted as part A. Part B consisted of prepolymer, which was added to part A, previous to applying product, and it was homogenized for 3-5 minutes.

### Example 6

One kilogram formula was prepared in a steel container, at environmental temperature, with the following composition: 27% w/w hydrogenated elastomer with hydroxyl functional groups; 14% w/w polybutadiene-based polyurethane prepolymer with 13% of isocyanate groups; 58.5% w/w aggregates, specifically sand with particle size not greater than 500 microns; 0.1% w/w carbon black; 0.2% w/w antioxidant, 0.2% w/w catalyst, specifically tin dibutyl dilaurate and 1.2% weight (related to total formula weight) of rheological modifier. Mixing sequence was as follows; first, hydrogenated elastomer and carbon black were mixed and aggregate was subsequently added, once homogeneous, antioxidant, rheological modifier and finally the catalyst were added, such mixing is denominated as part A. Part B consisted of prepolymer, which was added to part A, previous to applying product, and it was homogenized for 1-3 minutes.

### Example 7

One kilogram formula was prepared in a steel container, at room temperature, with the following composition: 27% w/w hydrogenated elastomer with hydroxyl functional groups; 14% w/w polybutadiene-based polyurethane prepolymer with 13% of isocyanate groups; 53.5% w/w aggregates, specifically sand with particle size not greater than 500 microns; 5% w/w aliphatic oil; 0.1% w/w carbon black; 0.2% w/w antioxidant, 1.2% weight (related to total formula weight) of rheological modifier and 0.2% w/w catalyst, specifically tin dibutyl dilaurate. Mixing sequence was as follows; first, aggregate and oil were mixed, hydrogenated elastomer, carbon black and antioxidant were subsequently added, when homogeneous, the catalyst was finally added, such mixing is denoted as part A. Part B consisted of prepolymer, which was added to part A, previous to applying product, and it was homogenized for 1-3 minutes.

### Example 8

One kilogram formula was prepared in a steel container, at room temperature, with the following composition: 27% w/w hydrogenated elastomer with hydroxyl functional groups; 14% w/w polybutadiene-based polyurethane prepolymer with 13% of isocyanate groups; 53.3% w/w aggregates, specifically sand with particle size not greater than 500 microns; 5% w/w aliphatic oil; 0.1% w/w carbon black; 0.2% w/w antioxidant, 1.2% weight (related to total formula weight) of rheological modifier and 0.4% w/w catalyst, specifically lauryl dimethyl amine oxide. Mixing sequence was as follows; first, aggregate and oil were mixed, hydrogenated elastomer, carbon black, antioxidant and rheological modifier were added, when homogeneous, the catalyst was finally added, such mixing is denominated as part A. Part B consisted of prepolymer, which was added to part A, previous to applying product, and it was homogenized for 2-5 minutes.

### Example 9

One kilogram formula was prepared in a steel container, at room temperature, with the following composition: 27% w/w hydrogenated elastomer with hydroxyl functional groups; 14% w/w polybutadiene-based polyurethane prepolymer with 13% of isocyanate groups; 53.3% w/w aggregates, specifically sand with particle size not greater than 500 microns; 5% w/w aliphatic oil; 0.1% w/w carbon black; 0.2% w/w antioxidant, 1.2% weight (related to total formula weight) of rheological modifier and 0.4% w/w catalyst, specifically tin dibutyl dilaurate. Mixing sequence was as follows; first, aggregate and oil were mixed, hydrogenated elastomer, carbon black, antioxidant and rheological modifier were subsequently added, when homogeneous, the catalyst was finally added, such mixing is denominated as part A. Part B consisted of prepolymer, which was added to part A, previous to sealer application, and it was homogenized for 1-3 minutes.

The composition of the present invention can be easily applied, once the two components (part A and part B) are mixed, without any previous preparation of substrate where composition will be applied.

Working time, just before it is not possible to manipulate the compound, can be adjusted varying from 5 minutes to 45 minutes, depending on the amount and type of catalyst to be used. Especially, if it is required to increase the working time for at least 25 minutes, lauryl dimethyl amine oxide is used in amounts not higher than 1% weight related to active species, i.e., polybutadiene based polyurethane prepolymer and the telechelic hydroxyl saturated polybutadiene.

When curing is required to be accelerated, such that free-tack is registered on the product surface, tin dibutyl dilaurate is used in amounts about 0.5% related to active species. Such free-tack time is about 130 minutes.

On Table 3, free-tack time values and shore A hardness values are shown for products obtained for each example cited above.

TABLE 3
Dry time and shore A hardness values

| | Dry timing, | Shore A |
|---|---|---|
| Example | min | hardness |
| 1 | 500 | 45 |
| 2 | 530 | 42 |
| 3 | 480 | 49 |
| 4 | 475 | 47 |
| 5 | 510 | 51 |
| 6 | 133 | 55 |
| 7 | 158 | 53 |
| 8 | 350 | 52 |
| 9 | 145 | 48 |

As noted on Table 3, using lauryl dimethyl amine oxide gives greater free-tack time compared to tin dibutyl dilaurate (example 8 vs. 7) with similar shore A hardness values. Generally, it is noted that there is a remarkable free-tack time reduction when a catalyst is used, along with the fact that obtained material shore A hardness slightly increases.

Besides, it seems that catalyst amount, for the tin dibutyl dilaurate case, after 0.2%, has a slight effect on hardness and dry timing, as shown when comparing such data on examples 7 and 9.

Compound flexibility and mechanical characteristics can vary according with the aggregate size and amount to be used; therefore, it is advantageous to use for common structures used as cement and/or plaster compresses, cement-based reinforcements reinforced with metallic or polymer nets, as well as covered films or layers.

Besides, it should be highlighted that it is traditional to use filler no more than 40% by weight in the formula, for example, on joints sealers, due to an important reduction of the resulting product flexibility. As noted herein, the materials' flexibility used is such that it allows increasing the filling percentage up to 70%, preferably between 40 and 60% weight of total formula, without any detriment of the properties such as shore A hardness. The above is an important differentiation of commercial products, together with filler and raw materials type used.

Another advantage of the present invention relates to the high resistance to hydrolysis comparatively with polyether and/or polyester type polyols-based polyurethanes traditionally used, allowing more stability for a period of time, derived from its polymeric structure. As mentioned above, when samples are submerged in hot water (70° C.), properties variation such as resistance to tension and elongation, is relatively small, not greater than 5% in break elongation and not greater than 13% in tensile strength.

What is claimed is:

1. A polyurethane compound, comprising:
(a) hydrogenated elastomer with hydroxyl functional groups;
(b) elastomer based polyurethane prepolymer;
(c) filler material; and
(d) at least one additive selected from the group consisting of antioxidants, rheological modifiers, oils, and carbon black.

2. A polyurethane compound as defined in claim 1, further comprising a catalyst.

3. A polyurethane compound as defined in claim 2, wherein the catalyst comprises an amine or tin compound.

4. A polyurethane compound as defined in claim 3, wherein the catalyst comprises triethanolamin, lauryl dimethyl amine oxide, or tin dibutyl dilaurate.

5. A polyurethane compound as defined in claim 4, wherein the catalyst comprises no greater than about 1% of the compound total weight.

6. A polyurethane compound as defined in claim 1, wherein the hydrogenated elastomer is a telechelic hydrogenated elastomer with hydroxyl groups.

7. A polyurethane compound as defined in claim 6, wherein the hydrogenated elastomer comprises from about 20% to about 40% of the compound total weight.

8. A polyurethane compound as defined in claim 1, wherein the polyurethane prepolymer is polybutadiene-based with methylene diphenyl diisocyanate.

9. A polyurethane compound as defined in claim 8, wherein the elastomer-based polyurethane prepolymer includes from about 8.0% by weight to about 14.0% by weight of isocyanate groups.

10. A polyurethane compound as defined in claim 9, wherein the elastomer-based polyurethane prepolymer comprises from about 10% to about 20% of the compound total weight.

11. A polyurethane compound as defined in claim 1, wherein the filler comprises at least one of sand, talc and/or calcium carbonate.

12. A polyurethane compound as defined in claim 11, wherein the filler has a particle size of no greater than about 1700 microns.

13. A polyurethane compound as defined in claim 12, wherein the filler comprises a mixture of sand and calcium carbonate and/or talc in a weight ratio of about 0.5 to about 2 of sand to calcium carbonate and/or talc.

14. A polyurethane compound as defined in claim 13, wherein the filler comprises from about 40% to about 70% of the compound total weight.

15. A polyurethane compound as defined in claim 1, wherein the additive comprises no greater than about 0.5 weight percent antioxidant, no greater than about 0.2 weight percent carbon black, no greater than about 1.5 weight percent rheological modifier, and no greater than about 6 weight percent aliphatic oil.
